(19) United States
(12) Patent Application Publication
(10) Pub. No.: US 2024/0360884 A1
(43) Pub. Date: Oct. 31, 2024

(54) COMPRESSION VALVE

(71) Applicants: SR SUNTOUR EUROPE GMBH, Warngau (DE); SR SUNTOUR INC., Chang Hua (TW)

(72) Inventors: Umberto ORSINI, Bologna (IT); Pierre-Geoffroy PLANTET, Holzkirchen (DE)

(73) Assignees: SR SUNTOUR EUROPE GMBH, Warngau (DE); SR SUNTOUR INC., Chang Hua (TW)

(21) Appl. No.: 18/685,348

(22) PCT Filed: Aug. 26, 2022
(86) PCT No.: PCT/EP2022/073791

§ 371 Date: Feb. 21, 2024

(30) Foreign Application Priority Data
Aug. 31, 2021 (DE) 10 2021 122 518.3

(51) Int. Cl. F16F 9/34; B62J 45/40; B62J 45/414; B62K 25/04; B62K 25/08; F16F 9/512

(52) U.S. Cl. CPC F16F 9/34; B62J 45/40; B62K 25/08; F16F 9/512; B62J 45/414; B62K 2025/044; F16F 2222/12; F16F 2228/066; F16F 2230/18

(57) ABSTRACT

The invention describes a compression valve (1) for a damper (2) of a suspension assembly (4) of a two-wheeled vehicle (3), the compression valve (1) comprising a cylindrical main body (10) adapted to be arranged along a longitudinal axis (2A) of the damper (2), the main body (10) comprising an interior cavity (100) in the form of an axial blind hole (100); a through-passage (101, 102) arranged to provide a fluid path (P101, P102) between a pressure tube (20P) and a reserve tube (20R) of the damper (2); a rotatable body (11) shaped to engage with the main body (10), which rotatable body (11) is rotatable between a first position (VP_open, VP_medium) in which the rotatable body (11) opens a fluid path (P101, P102), and a second position (VP_shut) in which the rotatable body (11) closes all fluid paths (P101, P102). The invention further describes a damper (2), a suspension assembly (4) and a method of controlling a suspension assembly (4).

The invention describes a compression valve, a damper, an electronic suspension, and a method of controlling an electronic suspension.

### BACKGROUND OF THE INVENTION

A two-wheeled vehicle such as mountain-bike is generally equipped with at least a front shock absorber, and the most common type of front shock absorber is a telescopic tube fork arranged between the bicycle header tube and the front wheel axle. A telescopic tube fork generally has a pair of stanchions, and each stanchion can slide in and out of a fork lower. A spring such as an air spring is accommodated in one stanchion, and a damper is arranged in the interior of the other stanchion to assist the spring. The damper side of the fork comprises a piston, a plunger, and a shock absorber. Various possible designs are known, the most common provides damping by regulation of fluid between a pressure tube (“working tube”) and a reserve tube. Various designs are known, for example a design based on a linear arrangement of reserve tube and pressure tube, a design based on a nested arrangement of pressure tube and reserve tube, etc. A compression valve regulates the flow of hydraulic fluid between these tubes and can usually be adjusted between an “open” position and a “shut” position. When the damper-side piston is forced up or down as the front wheel rolls over uneven terrain, the position of the compression valve determines the quantity and rate of fluid flow between the pressure tube and the reserve tube.

A commonly used compression valve is realised as a needle valve, with a hollow cylindrical body mounted at the top of the pressure tube, and a needle that can be moved into or out of the cylindrical body between “shut” and “open” positions of the valve. In older bicycle suspensions, the rider can manually open or close the front shock absorber by a damper control knob at the top of the stanchion on the damper-side, or by means of a control lever on the handlebar. In an electronic suspension (“e-suspension”), an actuator such as a small motor is used to open or close the valve, and sensors are used to detect impact to a shock absorber. However, a needle valve design can be problematic in the case of an e-suspension. This is because the upwardly-directed axial force following an impact to the shock absorber can result in large forces being axially transferred to the valve actuator, which might be a small battery-powered DC motor. The upward axial force means that the motor must work harder to keep the needle at its lower position in a “shut” setting, and this can result in wear on the motor, reducing its lifetime significantly. The battery power supply can deplete more quickly. Another drawback of this prior art needle valve is the difficulty of achieving a true “shut” setting, since the axial upward pressure from the plunger following an impact to the front wheel may force some fluid into the reservoir, with the result that the cartridge moves downward by an amount perceptible to the rider.

Therefore, it is an object of the invention to provide a compression valve that overcomes the problems outlined above.

### SUMMARY OF THE INVENTION

The object of the invention is achieved by the claimed compression valve, the claimed damper, and the claimed bicycle suspension assembly.

In the following, it shall be assumed that the damper comprises an essentially vertical linear arrangement of reserve tube and pressure tube, and that the compression valve is arranged at a junction between the reserve tube and the pressure tube.

According to the invention, the compression valve comprises an essentially cylindrical main body comprising an interior cavity in the form of an axial blind hole. This main body is formed so that it can be secured in the damper at a junction between pressure tube and reserve tube. The longitudinal axis of the main body preferably coincides with the longitudinal axis of the damper. The compression valve further comprises an essentially radial through-passage arranged to provide a fluid path between the pressure tube and the reserve tube of the damper, to provide a fluid path through the compression valve, i.e. to provide a fluid path through the compression valve. The compression valve further comprises a rotatable body that is shaped to fit the main body, and is rotatable between a first position in which the rotatable body opens or exposes a fluid path, and a second position in which the rotatable body closes or occludes all fluid paths. The rotatable body can be formed to fit inside the axial blind hole, or the rotatable body can be formed to fit about one end of the main body.

The axial blind hole closes the interior of the main body from the pressure tube in the axial direction, i.e. the base of the main body is closed off from the pressure tube. This has the effect that fluid from the pressure tube cannot pass into the main body in an axial direction. Instead, a number of fluid ports are provided in the wall of the main body.

An advantage of the inventive compression valve is that moving parts of the damper—the compression valve barrel and a coupling between the compression valve and an actuator—are not subject to upward axial force in response to an impact.

The purpose of the inventive valve is to provide high-speed reaction to a sudden impact. The desired level of damping is determined by the damper setting, for example “fully open” or “fully closed” and the corresponding position of the rotatable body of the compression valve: the rotatable body is turned to expose the orifice of a through-passage when damping is desired (the valve is at an “open” setting) or to occlude the orifices of any through-passage when damping is not desired (the valve is at its “closed” setting). In the following, the “shut” position of the damper valve may also be referred to as “closed” or “locked”.

A through-passage has an orifice that opens into the axial blind hole, and an orifice arranged to open into the reserve tube when the rotatable body is turned to expose a fluid path. In this way, a through-passage provides a fluid path between the pressure tube and the reserve tube. A through-passage is essentially radial, i.e. a through-passage extends at least partially in a radial direction between the interior and the exterior of the compression valve. Therefore, in the following, the terms “oil port”, “through-passage” and “radial through-hole” may be used interchangeably.

A through-passage can be formed or machined in any suitable way, for example by drilling. A through-passage preferably comprises a uniform cross-section along its length. A through-passage preferably comprises a circular cross-section along its length.

The inventive compression valve can be used in a damper of a suspension system of a two-wheeled vehicle such as a bicycle or motorbike, for example. Equally, the inventive compression valve can be used in a damper of a tricycle suspension system. The inventive compression valve can be used in the damper of a front shock absorber, and may equally be used in the damper of a rear shock absorber.

According to the invention, the damper comprises a pressure tube and a reserve tube in a configuration that will be familiar to the skilled person, and also an embodiment of the inventive compression valve arranged to regulate fluid flow between the pressure tube and the reserve tube.

According to the invention, the bicycle suspension assembly comprises a telescopic tube fork arranged between the bicycle header tube and the front wheel axle, which telescopic tube fork comprises a pair of stanchions and an embodiment of the inventive damper arranged in the interior of one stanchion. A suitable spring such as an air spring is accommodated in the other stanchion of the telescopic fork. The inventive suspension assembly can also comprise a rear shock absorber, which may also comprise an instance of the inventive damper.

The dependent claims and the following description disclose particularly advantageous embodiments and features of the invention. Features of the embodiments may be combined as appropriate. Features described in the context of one claim category can apply equally to another claim category.

The inventive compression valve can be used in any application that benefits from the advantages of the proposed design. For example, the inventive compression valve might be used in the front shock absorber of any two-wheeled vehicle that benefits from rapid and energy-efficient response to compression, e.g. a motorbike or a human-powered two-wheeled vehicle such as a bicycle. In the following, it may be assumed that the two-wheeled vehicle is a mountain-bike equipped with a telescopic fork as a front shock absorber, and an electronic suspension control arrangement. The two-wheeled vehicle can be human-powered or at least partially human-powered, for example a mountain-bike may be equipped with a motor.

A significant advantage of the inventive compression valve, as explained above, is that the rotatable body of the compression valve is not subject to axial upward forces when fluid is forced upwards following an impact to the front wheel. It shall be noted that a damper comprising the inventive compression valve will operate in the usual manner, i.e. an impact causes an upward displacement of the front wheel, resulting in an upward force on the plunger, which in turn acts to force hydraulic fluid upwards into the interior of the valve. Depending on the valve setting, hydraulic fluid will be impeded from passing to the reserve tube or allowed to pass to the reserve tube. However, the advantageous design of the compression valve ensures that the valve actuator can operate with less effort. Particularly in the case of an electronically operated valve actuator, isolation of the rotating body from the axial upward forces means that the valve actuator requires less power. This results in longer battery life and/or a smaller battery in the case of a battery-powered damper.

In one preferred embodiment of the invention, the rotatable body is shaped to fit within the main body, i.e. inside the interior cavity in the main body. In such an embodiment, the rotatable body can be in the form of a cylinder or rod, and one or more through-passages are formed through the otherwise solid body. Here, a through-passage can comprise an upper radial portion with an orifice opening into the reserve tube, a lower radial portion with an orifice arranged to line up with a fluid port in the wall of the main body, and an axial portion that connects the upper and lower radial portions.

In a particularly preferred embodiment of the invention, the rotatable body is shaped to fit about the upper end of the main body, i.e. it has an essentially cylindrical form, and may be referred to as a barrel in the following. In such an embodiment, one or more through-passages extend radially through the upper end of the main body. Here, a through-passage has an inner orifice opening into the axial blind hole and an outer orifice that opens into the reserve tube. The barrel has one or more apertures arranged to line up with the outer orifice of a through-passage. Without restricting the invention in any way, the following description may refer primarily to features of this embodiment.

The rotatable body is free to rotate relative to the main body but is preferably shaped to fit closely with only a low level of play, i.e. the main body and the rotatable body are machined to a very precise tolerance.

In a particularly preferred embodiment of the invention, the radial portion of a through-passage is essentially perpendicular to the axial blind hole. In such an embodiment, the hydraulic fluid being pushed axially upward by the plunger is forced to change direction essentially by 90° in order to exit the upper end of the compression valve main body during high-speed compression on its way from the pressure tube to the reserve tube.

The inventive compression valve can comprise one or more radial through-holes that serve to provide high-speed response to a sudden impact. For example, two diametrically opposed primary radial through-holes or oil ports may be formed in the upper region of the main body of the compression valve. The primary radial through-hole can preferably have a cross-sectional area in the order of 5 mm² to 15 mm², depending on the damper specifications (for example, the oil ports in a compression valve for the damper for a downhill bike may be larger compared to the oil ports in a compression valve of a damper for an all-mountain bike). The cross-sectional area of the axial blind hole in the interior of the valve is preferably chosen on the basis of the total cross-sectional area of the primary oil ports, as will be known to the skilled person.

In a further preferred embodiment of the invention, the damper may have more than one “open” setting, for example a “fully open” setting and a “medium” or “partially open” setting. In such an embodiment, the inventive compression valve comprises a secondary radial through-hole that serves to provide high-speed response to a less powerful impact. The amount of travel in the “medium” setting is lower than in the “open” setting. This is achieved by appropriate dimensions of the radial through-holes. The cross-sectional area of the smaller, secondary oil port can be in the order of 0.2 mm²-5 mm². In a particularly preferred embodiment of the invention, the cross-sectional area of the secondary oil port is preferably at least 10 times smaller than the cross-sectional area of the primary oil port, and can be even smaller, for example it may have a cross-sectional area that is 30 times smaller than the cross-sectional area of the primary oil port. Of course, the cross-sectional areas of the oil ports can be chosen in consideration of various factors, as will be known to the skilled person.

The primary and secondary radial through-holes described above are relevant for high-speed response to impact on the front wheel. As the skilled person will be aware, a damper of the type discussed herein can be constructed to provide high-speed compression and low-speed compression, for example to counteract “pedal bob”. This type of damper may be assumed to comprise various shim stacks arranged to achieve the desired level of compression as will be known to the skilled person.

The compression valve can be coupled to a valve actuator in any suitable manner. To this end, the rotatable body of the compression valve is preferably shaped to engage with a coupling means or transmission link arranged between the compression valve and a valve actuator.

In a preferred embodiment of the invention, the suspension assembly comprises a sensor arrangement configured to generate an output signal in response to a displacement of the sprung mass. In other words, any movement of the sprung mass relative to the damper is detected. The term “sprung mass” is used in its accepted sense, and shall be understood to mean the mass that is supported by the front shock absorber. For example, a sudden impact to the front wheel results in an upward deflection of the fork lowers along with the plunger in the damper-side of the fork and—depending on the damper setting—a relative downward displacement of the fork stanchions. A sensor arrangement is therefore preferably located near the upper end of a stanchion. Of course, a sensor can be located at any suitable position, for example on or near the handlebars, the bicycle header tube, in the damper side of the fork, etc. Preferably, the sensor arrangement comprises a one or more sensors configured to detect movement of the sprung mass in three orthogonal axes. In a particularly preferred embodiment of the invention, the sensor arrangement comprises a three-axis accelerometer, in the form of a chip-scale package, that can detect motion along three orthogonal axes and which can output a first digital signal encoding displacement along the X-axis, a second digital signal encoding displacement along the Y-axis, and a third digital signal encoding displacement along the Z-axis. A pressure sensor may be deployed in the spring-side of the damper, and a pressure sensor reading may be used to determine the force of impact to the damper. A potentiometer or similar device may be used to measure the rate of axial displacement of the stanchions relative to a fixed reference, i.e. relative to the un-sprung mass.

In a further preferred embodiment of the invention, the suspension assembly comprises an electronically controlled valve actuator (e.g. a DC motor) coupled to the rotating body of the compression valve, and a control arrangement configured to operate the valve actuator on the basis of a sensor arrangement output signal.

Such a suspension assembly can be controlled as follows: the output signals of the sensor arrangement are analysed essentially continuously (e.g. every millisecond) to detect displacement of the sprung mass. If a displacement is considered to be significant enough to require damping, control signals are generated to operate the valve actuator to effect a rotation of the barrel of the compression valve to reveal the orifice of the relevant radial through-hole. For example, any impact resulting in a deflection that exceeds a predefined high-impact threshold will put the damper in its “fully open” setting (the valve actuator turns the rotating body to reveal the orifice of the primary radial through-hole). If the damper has a “medium” setting in addition to a “fully open” setting, the valve actuator will be operated accordingly, i.e. any impact resulting in a deflection that exceeds a predefined medium-impact threshold will put the damper in its “medium” setting (the valve actuator turns the rotating body to reveal the orifice of the secondary radial through-hole).

The inventive suspension arrangement can comprise a processor configured to perform signal processing on the sensor signals using appropriate algorithms and to execute steps of a control program stored in a memory. In a particularly preferred embodiment of the invention, various hardware components of a control arrangement (e.g. integrated circuits, a flash memory, one or more sensors, one or more chip-scale packaged sensors, etc.) are mounted on a printed circuit board (PCB) that fits inside the damper cartridge, for example inside a top cap that is screwed onto the damper-side stanchion. A power connector can connect a power supply (e.g. a battery arranged in the down tube of the bicycle) to provide power at suitable voltage levels to the components of the electronic suspension.

An electronic suspension of a mountain-bike generally collects various input signals and processes these to generate an appropriate control signal for a damper valve. Input signals can be continuously delivered by suitable sensors, for example an accelerometer may provide its output signals at a frequency of 1 kHz.

In principle, a mountain-bike e-suspension aims to control a damper valve on the basis of any detected impact and also on the direction of motion. By evaluating the X-axis and Y-axis accelerometer signals, for example, an electronic suspension can determine whether the rider is travelling downhill. On a bumpy downhill track, the mountain-bike e-suspension will then open the compression valve of the front fork damper whenever the front wheel impacts an obstacle. A large force of impact can result in a longer “open” valve position. The valve may be closed quickly if the force of impact was only slight. In this way, a smooth downhill ride can be experienced even if the surface is very rough.

Upon impact to the front fork of the suspension, the sprung mass moves towards the un-sprung mass (the “un-sprung mass” of a mountain-bike front shock absorber essentially comprises the front wheel and the fork lowers; the “sprung mass” essentially comprises everything else). The force of impact depends to a large extent on the inclination of the bike. When travelling downhill, the rider's weight is transferred to a large extent through the handlebars to the front shock absorber, thereby contributing to the force of impact.

When travelling uphill on uneven terrain, obstacles such as large stones or rocks, tree roots etc. may need to be overcome in order to avoid having to dismount. The rider may pull the handlebars upwards in one quick motion to lift the front wheel over the obstacle. To maintain speed, the damper should be controlled in response to the ensuing impact when the front wheel meets the track once more.

However, when travelling uphill, the rider's weight is transferred primarily through the seat-post to the back wheel. For the reasons given above, the force of impact to the front wheel is then lower. As a result, a prior art mountain-bike e-suspension may fail to reliably identify an impact to the front wheel when it lands back on the ground after having been quickly lifted over an obstacle as described above. The outcome of the conventional e-suspension response may be that the bike loses speed, so that an obstacle-ridden uphill climb can be very strenuous for the rider.

The inventive method presents a solution to this problem. The invention is based on the insight that sensor signals can also be used to deduce whether the sprung mass is being pulled away from the un-sprung mass of the suspension. The inventive approach is to respond when the rider pulls the handlebars upward in a sudden motion, since this action is characteristic for overcoming an obstacle in a non-downhill scenario. In other words, the inventive method allows the e-suspension to respond as soon as the front wheel is lifted, so that the front fork damper is set to “open” even before the front wheel lands once again on the track.

To this end, the inventive method applies digital signal processing (DSP) techniques to process the output signals of the sensor arrangement in order to detect an upward inclination (using the X-axis and Y-axis information) and also to detect an upward movement of the sprung mass (using the Z-axis information). The velocity of the upward movement can be compared to a suitable threshold. Using this data, the control arrangement can correctly identify the situation described above (the rider has abruptly pulled on the handlebars to lift the front wheel) and responds by opening the front fork damper valve in readiness for the subsequent impact. From the point of view of the rider, lifting the front wheel over an obstacle while riding uphill is followed by a smoothly damped impact as the front wheel meets the track again. An advantage of the inventive control approach is that an obstacle-ridden uphill ride is less strenuous for the cyclist and more energy-efficient.

The inventive suspension assembly can also respond favourably to other situations that are not identified by conventional e-suspensions. For example, the mountain bike may be ridden over terrain that not smooth but also not blocky, for example a ridged terrain. Movement over such terrain—in the absence of damping—can manifest as an unfavourable oscillation or vibration of the front wheel and handlebar, and this vibration is transferred to the rider, who may find it difficult to focus clearly on the path ahead. In such terrain, a conventional electronic suspension may respond unfavourably: the front fork damper may be kept “shut” since the magnitude of the impacts may be deemed insufficient to warrant opening the front shock absorber; or the front shock absorber is opened and closed intermittently and in an apparently random manner. The inventive approach is to identify a situation in which low-force to medium-force impacts follow in quick succession, and to keep the front fork damper in an appropriate “open” position while moving over such terrain. To this end, the control arrangement of the inventive damper is configured to detect vibration of the sprung mass and to open the damper in response to the detected vibration.

In a further situation not identified by a conventional e-suspension, the inventive suspension assembly can be controlled to respond to a sudden downward displacement of the front wheel. For example, when travelling downhill, the ground may fall away abruptly. As a result of the abrupt change in terrain, the front wheel will drop suddenly relative to the handlebars, while maintaining contact with the ground. In this situation, the damper of the inventive suspension assembly reacts by opening fully in anticipation of the subsequent “impact” when the unsprung mass (the front wheel) would act to push the fork lowers upwards again. This response is based on the insight that the rider is in the safe downhill position, seated far back with arms outstretched towards the handlebars, i.e. the rider is neither pulling on the handlebars nor exerting any significant pressure on the handlebars, when the ground suddenly becomes steeper downhill. In combination, the deduced downhill inclination of the bike from the accelerometer data and the sudden downward movement of the fork (e.g. at a rate of 1800 mm/s), allows the controller to deduce that the ground has fallen away steeply and to issue a command to open the damper valve in anticipation of the ensuing impact.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 shows a mountain-bike equipped with an embodiment of the inventive suspension assembly;

FIG. 2 shows a damper and front fork of the suspension assembly of FIG. 1;

FIG. 3 shows an embodiment of the inventive compression valve;

FIG. 4 shows a cross-sectional view of an embodiment of the inventive damper;

FIGS. 5-7 show various positions of a further embodiment of the inventive compression valve as implemented in FIG. 4;

FIG. 8 shows an exploded view of the compression valve of FIGS. 5-7;

FIG. 9 shows a prior art compression valve;

FIG. 10 is a block diagram of an exemplary e-suspension control arrangement;

FIG. 11 illustrates an exemplary embodiment of the control arrangement;

FIGS. 12-15 show exemplary computation blocks of the control arrangement of FIG. 11;

FIG. 16 and FIG. 17 illustrate a response of the control arrangement in an exemplary situation;

FIG. 18 illustrates a response of the control arrangement in a further exemplary situation;

FIG. 19 shows a downhill situation that is detected by the control arrangement.

In the drawings, like numbers refer to like objects throughout. Objects in the diagrams are not necessarily drawn to scale.

### DETAILED DESCRIPTION OF THE EMBODIMENTS

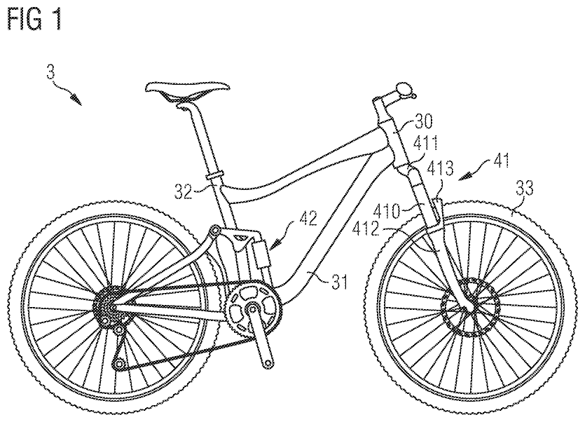

FIG. 1 shows an exemplary mountain-bike 3 that may be equipped with a suspension assembly 4 that deploys an embodiment of the inventive damper 2. This exemplary mountain-bike 3 is equipped with full-suspension, i.e. it has a front shock absorber 41 and also a rear shock absorber 42. Such a mountain-bike is commonly referred to as a “fully”.

In the exemplary embodiments described herein, the front shock absorber 41 is part of an electronic suspension, and the rear shock absorber 42 may also be included in that electronic suspension. A battery pack for providing power to components of the suspension assembly 4 can be arranged in the down tube 31 of the mountain-bike 3.

The front shock absorber 41 is realised as a telescoping fork arranged between the front wheel axle and the head tube 30 of the bicycle 3. In this configuration which will be familiar to the skilled person, the front shock absorber 41 has a spring side (usually containing an air spring) and a damper side (shown here on the right-hand side of the bike 3) containing a damper to assist the spring. This type of “front shock” 41 has an upper assembly comprising two stanchions 410 connected by a crown 411 for mounting the fork 41 to the bicycle's head tube 30, and a bottom assembly comprising a pair of lowers 412 connected by an arch 413, and with dropouts for connection to the front wheel axle. The stanchions 410 can slide in and out of the fork lowers 412 during compression and rebound, depending on the damper settings and the terrain.

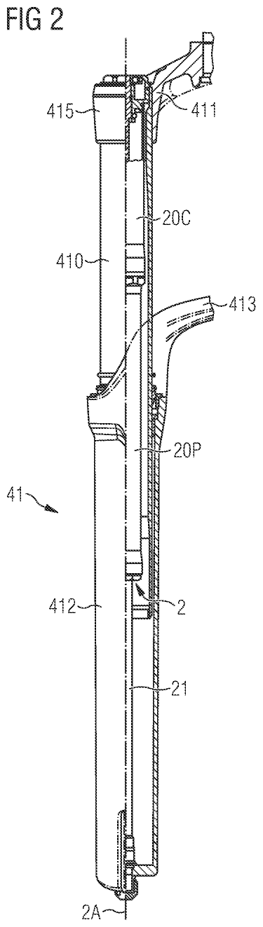

The damper side of a fork 41 and a damper 2 are shown in FIG. 2. The damper 2 has a plunger 21 arranged in the fork lower 412, a pressure tube 20P, and a cartridge 20C. The cartridge 20C is arranged inside a stanchion 410. When the front wheel 33 impacts against an obstacle, the ensuing upward force pushes the plunger 21 into the pressure tube 20P or “working tube” by a distance (“travel”) that is governed by the damper settings. The stanchion 410 accordingly appears to drop by that amount of travel. An “open” damper setting will soften the impact felt by the rider. The design and construction of the damper 2 determines the rate at which the front shock absorber compresses and returns from compression (rebounds) by a controlled exchange of hydraulic fluid (usually oil) between a pressure tube and a reservoir of the damper.

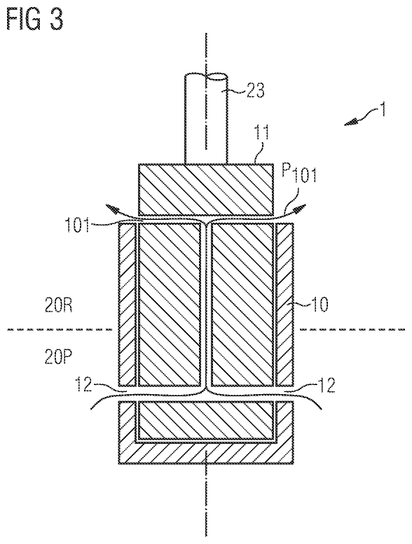

As will be known to the skilled person, such a damper 2 can be actuated between its open and shut positions to control the amount of travel, i.e. the distance by which the plunger 21 can move relative to the pressure tube 20P when the front wheel meets an obstruction. FIG. 3 shows an exemplary embodiment of the inventive compression valve 1 in cross-section. Here, the rotatable body 11 is shaped to fit inside the interior cavity in the main body 10. The rotatable body 11 has the form of a rod, with through-passages 101 formed to link the reserve tube 20R and the pressure tube 20P (indicated here as distinct regions of the damper). The through-passage 101 has an upper radial portion with an orifice opening into the reserve tube 20R, a lower radial portion with an orifice arranged to line up with a fluid port 12 in the wall of the main body 10, and an axial portion that connects the upper and lower radial portions. The rod 11 can be turned by the transmission link 23 to open the fluid path P101 (lower orifice lines up with fluid port 12) or to shut off the fluid path (lower orifice opens onto the inner surface of the main body).

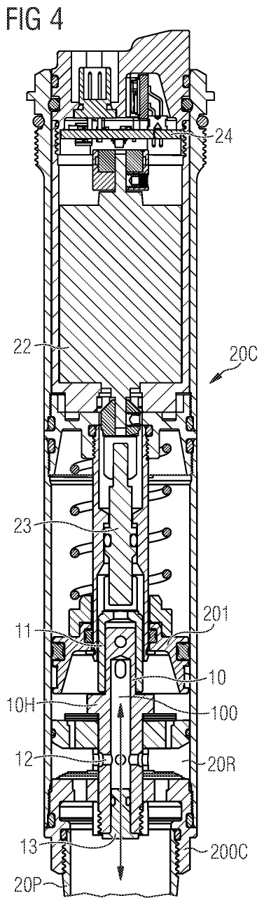

FIG. 4 shows a further exemplary embodiment of the inventive compression valve 1 in cross-section, as it might be arranged in the cartridge 20C of a damper 2. The main body 10 of the valve 1 is screwed into a connector 200 which in turn can be screwed onto the top of the pressure tube 20P. Here, the valve 1 is arranged underneath a spring-biased internal floating piston 201. Various components such as seals, threads, lockout piston, spacers, low-speed and high-speed shim stacks etc., will be known to the skilled person and therefore do not need not be described here in any detail.

The diagrams show a printed circuit board (PCB) assembly of a control arrangement 24, a DC motor 22, a transmission joint 23 and a compression valve 1. These modules are located in the cartridge 20C inside one stanchion 410 of the front fork 41, which is closed off by a top cap 415. The control arrangement 24 can comprise various modules as will be explained below. The inventive damper valve 1 or compression valve 1 comprises a rotatable barrel 11 that can be turned by the transmission joint 23 to expose or occlude an orifice of a radial through-hole, i.e. to regulate the quantity of hydraulic oil that can pass between the pressure tube 20P and the reservoir 20R, as indicated by the arrow. The compression valve 1 comprises a hex nut 10H to facilitate mounting the valve 1 inside a damper 2 of the type shown in FIG. 2, as well as a threaded lower end 202 for screwing into the connector 200.

Fluid ports 12 that open into the pressure tube 20P are shown, along with a spacer that sits about the main body 10 at that level. The interior cavity 100 or blind hole 100 is defined by the cylindrical wall of the main body 10, the closed upper end of the main body 10, and an end cap 13 that acts to close off the base of the main body 10. The end cap 13 can be a permanent rivet or plug, for example.

FIGS. 5-7 show the inventive compression valve 1 in various positions. In this exemplary embodiment, the main body 10 of the valve 1 has diametrically opposed primary radial through-holes 101 and one secondary radial through-hole 102, and the barrel 11 has diametrically opposed fluid apertures 11A, allowing a total of three possible valve positions as will be explained in the following.

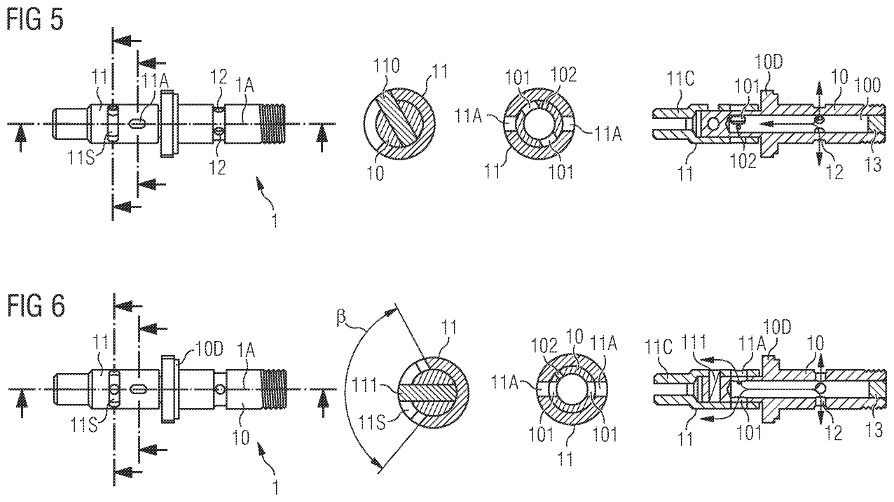

From left to right, each diagram shows a plan view of the valve 1, a cross-section through the barrel 11 at the level of a lateral slot 11S, a cross-section (enlarged for clarity) through the barrel 11 at the level of the barrel's fluid apertures 11A, and a cross-section along the longitudinal axis 1A of the valve 1. The slot 11S receives a pin 111 that extends radially from the upper end of the main body 10 of the valve 1. The outer limits of rotation of the barrel 11 are defined by the length of the slot 11S, which defines an arc subtending an angle β as indicated in FIG. 6. This angle can be in the order of 90°-120° for example.

In the drawings, the barrel 11 appears stationary and the valve main body 10 and pin 111 appear to move relative to the barrel 11. However, it shall be understood that the valve main body 10 is immovably fixed to the pressure tube 20P and that the barrel 11 rotates about the valve main body 10 by a rotating action of the transmission joint 23 when turned by the valve actuator 22.

In FIG. 5, the valve 1 is in its “shut” position: the barrel 11 is turned to occlude the outer orifices of both primary and secondary radial through-holes 101, 102. This “shut” valve setting may be the preferred choice when cycling along relatively smooth terrain, when cycling uphill, etc.

In FIG. 6, the valve 1 is in its “fully open” position: here, the barrel 11 is turned to expose the outer orifice of both primary through-holes 101. This position may be chosen when cycling downhill. This diagram illustrates a significant advantage of the inventive compression valve 1: in response to an impact to the front wheel, the plunger 21 is driven upward and hydraulic fluid is pressed into the axial blind hole 100 of the valve 1. However, the novel arrangement of axial blind hole 100 and radial through-holes 101, 102 means that the fluid can only exit the valve 1 in a “sideways” or radial direction. Therefore, the pressure of the hydraulic fluid cannot be transferred upwards in an axial direction, with the result that loading on a small DC motor or other actuator via the transmission joint is negligible. As a result, the lifetime of the DC motor and the lifetime of a battery power supply can be favourably extended.

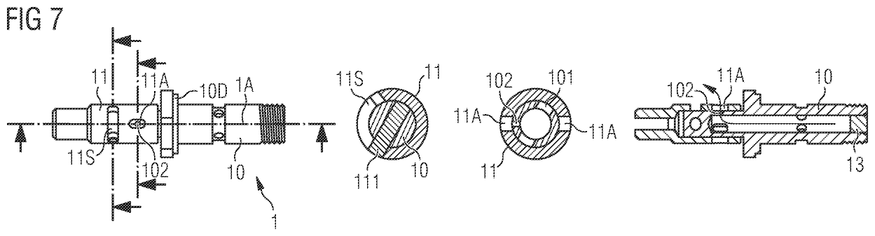

In FIG. 7, this exemplary embodiment of the inventive compression valve 1 is in its “medium” position: here, the barrel 11 is turned to expose the outer orifice of the secondary, significantly smaller, radial through-hole 102. This position may be chosen when cycling over moderately rough terrain, for example. This diagram illustrates a further advantage of the inventive compression valve 1: in response to a moderate impact to the front wheel, the plunger 21 is driven upward as explained above, and hydraulic fluid is pressed into the hollow interior 100 of the valve 1. The novel inclusion of the narrow secondary through-hole 102 means that it is possible to allow a controlled small quantity of hydraulic fluid to exit the valve 1, again in a “sideways” or radial direction as explained above. As a result, the inventive damper can provide an intermediate damping level which may be beneficial when cycling over terrain that is neither smooth nor particularly rough.

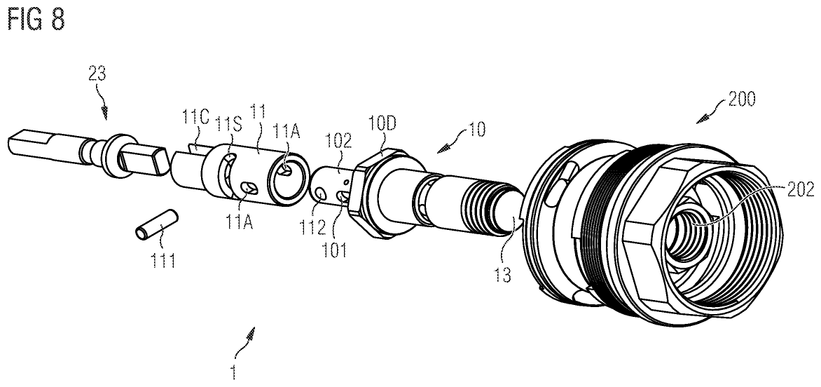

The exploded view given in FIG. 8 shows the rotatable barrel 11, the valve main body 10 and the limit pin 111. The diagram also shows the transmission joint 23 with which the DC motor is coupled to the barrel 11, and a threaded connector 200 with an inner threaded part 202 to receive the threaded end of the valve 1, and which can be threaded onto the top of the pressure tube 20P. The diagram shows a permanent cap 13 or plug in place at the base of the main body 10. The cap 13 serves to close off the interior cavity 100 that was drilled or otherwise machined into the main body 10.

The pin 111 is held in a corresponding seat 112 in the upper end of the valve main body 10, and extends radially outward through the barrel slot 11S. Together, the slot 11S and pin 111 define the barrel's limits of rotation (and the damper travel). In the valve's “fully open” setting, this radial through-hole 101 allows a relatively large quantity of hydraulic fluid to rapidly pass from the pressure tube 20P to the reservoir 20R, for example in response to a significant upward impact on the front wheel of the bike 3. A secondary radial through-hole 102 is shown here, with a significantly smaller diameter as explained above. In the valve's “medium” or “partially open” setting, the significantly smaller orifice of this through-hole 102 allows only a very small quantity of hydraulic fluid to pass from the pressure tube 20P to the reservoir 20R, for example in response to slight impacts on the front wheel of the bike 3.

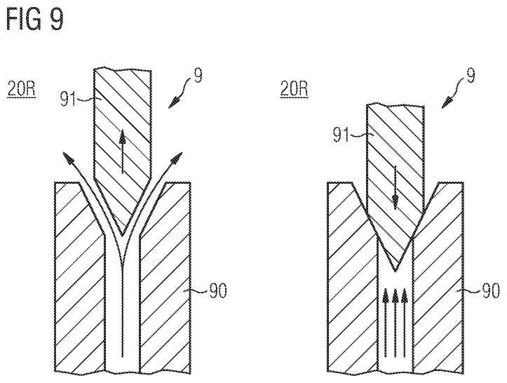

The inventive compression valve 1 as described above has a number of advantages over the needle valve that is commonly used in prior art dampers with a structure similar to that shown in FIG. 1. FIG. 9 shows two cross-sections through a needle valve 9 of a prior art damper, showing a stationary valve body 90 (usually mounted at the top of the pressure tube) and a moveable needle 92 which can be moved along an axis of translation between “open” and “shut” positions of the valve 9. The upper end of an interior cavity 91 opens into the reserve tube. The needle 91 is moved axially, i.e. up and down, as indicated by the double-ended arrow.

At its highest position as shown on the left, corresponding to the “open” position of the valve, the needle 91 allows hydraulic fluid to pass freely from the pressure tube to the reservoir. The needle 91 is shaped to fit into the valve when moved to its lowest position as shown on the right, corresponding to the “shut” position of the valve. In this position, hydraulic fluid is largely inhibited from passing from the pressure tube to the reservoir.

Upwardly-directed axial forces arise when fluid is forced upward by the plunger as shown here. These upwardly-directed axial forces are transferred axially to the valve actuator.

A drawback of the prior art compression valve 9 of FIG. 9, specifically in the case of an electronically controlled damper, is that the axial upward force on the needle 91 is transferred upward via a transmission link to the actuator, usually a DC motor. The motor must work harder to keep the valve 9 in its shut position, and wear on the motor can reduce its lifetime significantly. Furthermore, a power supply (usually a battery) can deplete more rapidly. Another drawback of this prior art needle valve 9 when used in an e-suspension is the difficulty of achieving a true “shut” setting, since the axial upward pressure from the plunger following an impact to the front wheel may force some fluid into the reservoir, with the result that the cartridge moves downward by an amount perceptible to the rider.

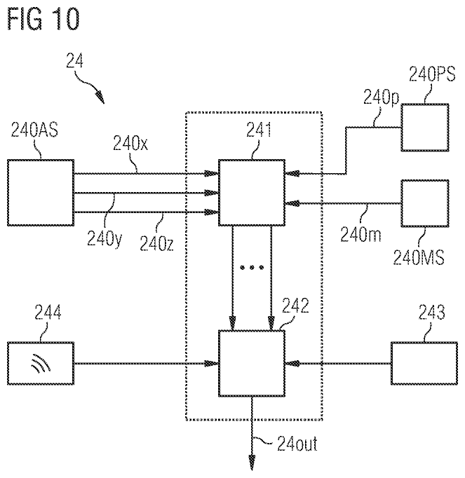

A mountain-bike front shock absorber can be controlled by means of a manual lockout control. This can be provided as a knob or lever accessible to the rider, for example a lockout control located on the handlebar or at the top of the damper-side leg of the fork. In a preferred embodiment of the invention, the damper 2 in the front fork of the mountain-bike 3 is part of an electronic suspension. As shown in FIG. 4, components of a control arrangement 24 of the damper 2 can be organized on a small PCB located in the damper-side leg of the fork 41. FIG. 10 is a simplified block diagram of a front shock control arrangement 24 and shows a tri-axis accelerometer 240AS that outputs displacement 240x, 240y, 240z along three orthogonal axes. Using a common convention, the X-axis may correspond to the forward direction of movement of the bike, the Y-axis may be perpendicular to the X-axis in a horizontal plane, and the Z-axis may correspond to the vertical. In the following, it shall be understood that the accelerometer outputs are interpreted to allow for the orientation of the sensor, for example the Z-axis reading is interpreted to consider the angle of inclination of the front fork relative to the true vertical.

The damper control arrangement 24 can also avail of a pressure sensor 240PS arranged to measure pressure 240p in the damper spring side and/or a motion sensor 240MS arranged to measure motion 240m of a stanchion.

The sensor outputs 240x, 240y, 240z, 240p, 240m forwarded to a signal processing module 241 which can apply various DSP algorithms and which sends the results to an evaluation module 242. In order for the evaluation module 242 to generate appropriate control signals 24out for the actuator 22, some other information is necessary, for example the current position of the barrel 11 of the damper valve 1 is also monitored, for example by an incremental encoder 243, and the barrel position (“fully open”, “medium” or “shut”) is reported to the evaluation module 242. The input signals to the evaluation module 242 are continually received and evaluated, and the evaluation module 242 generates an appropriate control signal 24out for the DC motor 22, which then actuates the transmission joint 23 accordingly.

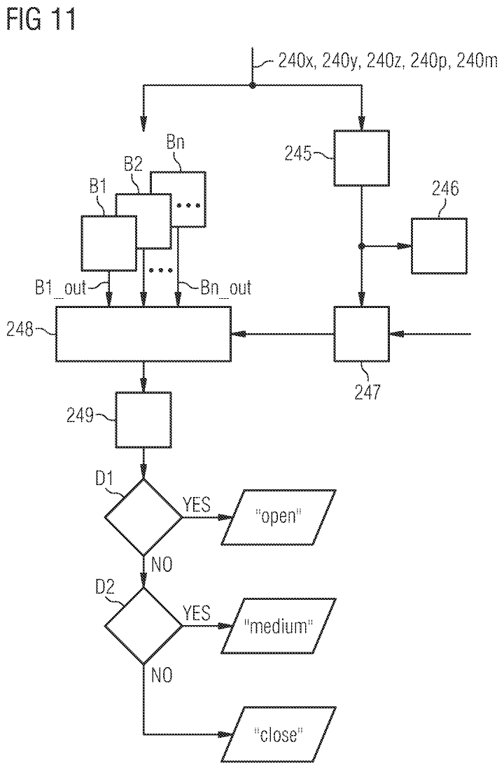

To control the damper in response to impacts to the front wheel in a downhill situation, for example, the control arrangement 24 processes the accelerometer signals 240x, 240y, 240z to determine slope and to derive the force of impact. On a bumpy downhill track, the mountain-bike e-suspension will then open the compression valve of the front fork damper whenever the front wheel impacts an obstacle, and the damping duration is proportional to the force of impact. Following a large impact, the valve is maintained in its “open” position for a longer duration; following a small impact, the valve is maintained in its “open” position for a short duration. A simplified diagram of such a decision tree is shown in FIG. 11, and represents the functionality of the DSP module 241 and the decision module 242 of the control arrangement 24 of FIG. 10. The diagram indicates a number of computation blocks B1, . . . , Bn. Each computation block B1, . . . , Bn receives one or more accelerometer signals 240x, 240y, 240z and delivers a computation result B1_out, . . . , Bn_out. A slope computation block 245 deduces the slope of the terrain from the accelerometer signals 240x, 240y, 240z. The output of the slope computation block 245 is used by a recovery time computation block 246 which computes the recovery time of the damper, and also by a shock threshold computation block 247 which is informed of the actual suspension setting (e.g. any of “open”, “medium” or “lock”).

The computation block outputs B1_out, . . . , Bn_out and the computed shock threshold are forwarded to a comparator module 248 which compares its input data to various pre-defined thresholds in order to deduce the type of impact (large impact or small impact). The outcome of a negative comparison (i.e. the force of impact does not exceed any of the thresholds) has no effect, so that the suspension remains “shut”. The outcome of an affirmative comparison (i.e. the force of impact exceeds a threshold) is to reset a timer in block 249, which then commences counting. In response to a large impact, a large-impact timer is reset to null; in response to a small impact, a small-impact timer is reset to null. A timer increments at a suitable rate, e.g. 1 kHz. In a first decision block D1, the large-impact timer is compared to the recovery time that was determined in block 246. The suspension is kept “open” as long as the large-impact timer count is lower than the recovery time, otherwise control proceeds to the second decision block D2. In the second decision block D2, the small-impact timer is compared to the recovery time that was determined in block 246. The suspension is kept at the “medium” setting as long as the small-impact timer count is lower than the recovery time, otherwise the suspension is “shut” (the timers are allowed to keep incrementing until the next reset).

The outputs of the decision blocks D1, D2 can be understood to correspond to the valve control signal 24out of FIG. 10. These diagrams are merely by way of example, and the skilled person will be aware that there are many ways of processing accelerometer signals to arrive at appropriate damper settings.

The compression valve of the front fork damper may generally be kept closed when the accelerometer signals 240x, 240y, 240z indicate that the rider is travelling uphill or on a level track. The inventive control method can respond to an upward pull on the handlebars when the rider lifts the front wheel to overcome an obstacle as explained above. To this end, the inventive control method extracts relevant information from the accelerometer signals as explained in the following.

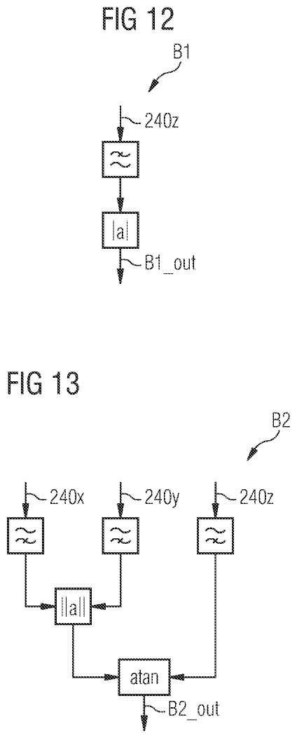

FIG. 12 shows a first computation block B1. This block B1 includes two stages: a first stage performs high-pass filtering on the Z-axis accelerometer output; a second stage computes the absolute value of its input. The output B1_out of this block B1 is therefore the absolute value of the high-pass filtered Z-axis accelerometer signal, i.e. the magnitude of an impact.

FIG. 13 shows a further computation block B2. This block B2 includes three stages: a first stage performs low-pass filtering on each of the accelerometer outputs; a second stage computes the norm of its inputs (the low-pass filtered X-axis signal and the low-pass filtered Y-axis signal). The output of the second stage and the low-pass filtered Z-axis are passed to a third stage which applies the arctan function to its inputs. The output B2_out of this block B2 is the slope of the terrain.

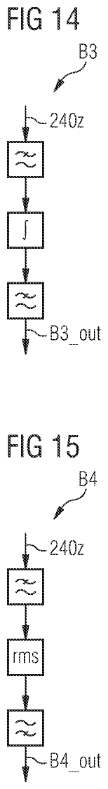

FIG. 14 shows a further computation block B3. This block B3 includes three stages: a first stage performs high-pass filtering on its input, for example the Z-axis accelerometer output 240z as shown here; a second stage computes the integral of its input; the third stage performs high-pass filtering on its input. The output B3_out of this block B3 indicates movement in the Z-direction and one of its uses in the inventive method is to deduce an upward movement of the sprung mass. The upward lifting action can be deduced from the Z-axis accelerometer output 240z as shown here and/or from a pressure sensor output 240p and/or from a motion sensor output 240m as explained above. An upward lift detection means can comprise any units or modules that collectively evaluate the sensor output(s) to determine whether an upward pulling force is acting on the damper 2.

FIG. 15 shows a further computation block B4. This block B4 includes three stages: a first stage performs high-pass filtering on the Z-axis accelerometer output; a second stage computes the root mean square (rms) of its input; the third stage performs low-pass filtering on its input. The output B4_out of this block B4 can be used to deduce “vibration”, i.e. a situation in which the bike is being ridden over ridged or prolonged bumpy terrain so that the shock absorber encounters impacts in quick succession.

Any number of further computation blocks may be included, for example a computation block that determines whether the bike is in free-fall.

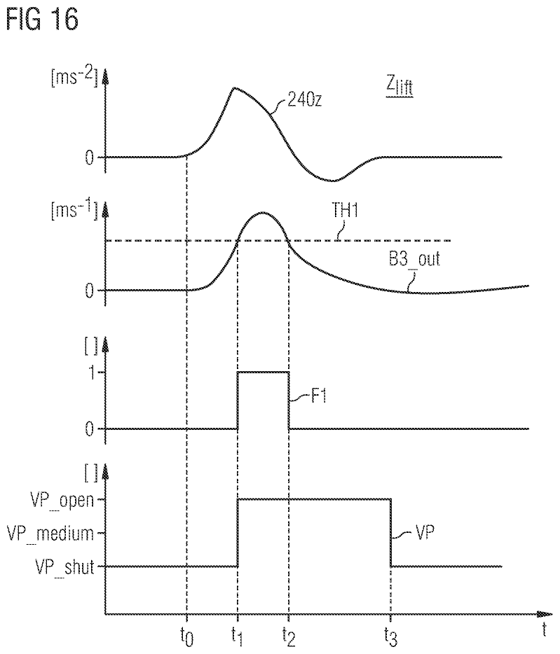

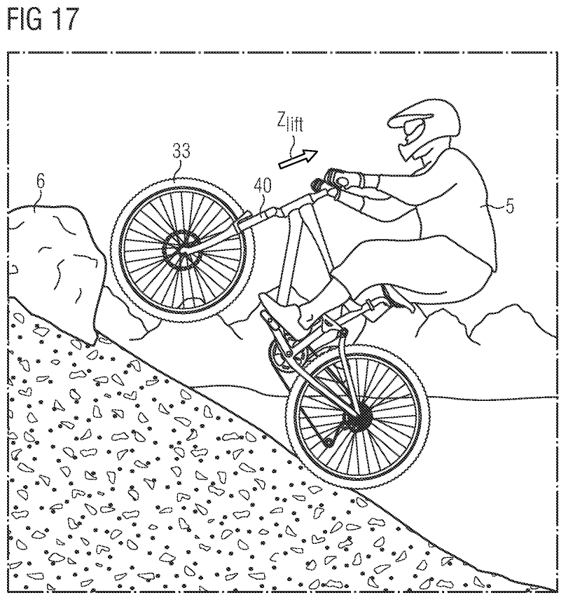

FIG. 16 illustrates the response of the control arrangement when the rider lifts the front wheel to overcome an obstacle. The diagram shows four signals. The uppermost curve is the Z-axis accelerometer output 240z as it might appear when the rider suddenly pulls the front wheel upwards at time to. The next curve is the high-pass filtered integral B3_out of computation block B3, i.e. the velocity in the upward Z-direction. When this variable exceeds a predefined threshold TH1, a flag F1 (indicating that upward movement has been detected) is set to “high”, and the front damper control signal 24out is set to “open” the valve, so that the valve position VP changes from “shut” to “open” at time t1.

Flag F1 remains “high” until the speed in the upward Z-direction (B3_out) drops below the threshold T1. From this time t2, the front damper control signal 24out ensures the valve position VP remains “open” for the recovery time duration, after which the front damper control signal 24out issues a command that changes the valve position VP to “shut” at time t3. This will result in the barrel 11 of the compression valve 1 being turned to occlude all radial through-holes of the compression valve. The delay between time to (rider pulls on the handlebar) and time t1 (the damper is “open”) is favourably low: within about 100 μs, an upward pull on the handlebar is detected and the order to open the valve is issued. Within about 3 ms, the valve actuator 22 has turned the rotating body of the valve to open the fluid path between pressure tube and reserve tube, indicated here at time t1. This favourably brief reaction time can be perceived by the rider as essentially instantaneous.

The damper may stay “open” for a suitable duration, for example 1 s, after which it returns to the “shut” position as indicated here at time t3. Of course, the length of time to keep the damper valve “open” is preferably chosen under consideration of the magnitude of the impact, and whether the rider is moving uphill, downhill or over flat terrain. The control arrangement can determine these variables, and can open the damper valve accordingly. For example, a relatively low-force impact can be followed by an “open” damper position for 1 second when the rider is travelling uphill or on flat terrain; when travelling downhill, a similar low-force impact can be followed by an “open” damper position for up to 2 seconds; a large-impact shock when the rider is travelling uphill or on flat terrain can be followed by an “open” damper position for up to 1.2 seconds, while a similar large-impact shock can be followed by an “open” damper position for 3.5 seconds.

The force of impact can be expressed in terms of gravitational force equivalent (“g-force”, abbreviated to italic g). For example, an impact in the order of 5 g-6 g felt when the rider is travelling downhill may be classed as “high impact” or “high-force impact”; but an impact in the order of 17 g when the rider is travelling uphill may be classed as “low impact” or “low-force impact”.

The inventive control method exploits the knowledge that a rider travelling steadily uphill is generally moving more slowly, and unevenness in the terrain generally does not impact with much force against the front wheel. However, when the rider 5 (travelling uphill) suddenly pulls on the handlebar, for example to lift the front wheel of the bike 3 over a large obstacle 6 as shown in FIG. 17, this action is sensed as a high g-force, for example in the order of 16 g-18 g. As a result of the upward pull Zlift on the handlebars, the stanchions are pulled rapidly out of the fork lowers, for example at a rate in the order of 1800 mms-1. Having deduced the uphill inclination of the bike from the accelerometers X and Y data, this combination of variables (high g-force and high stanchion speed) can be used to deduce the occurrence of an upward pulling action Zlift on the handlebars and to issue a command to open the damper valve, as illustrated in FIG. 16 above.

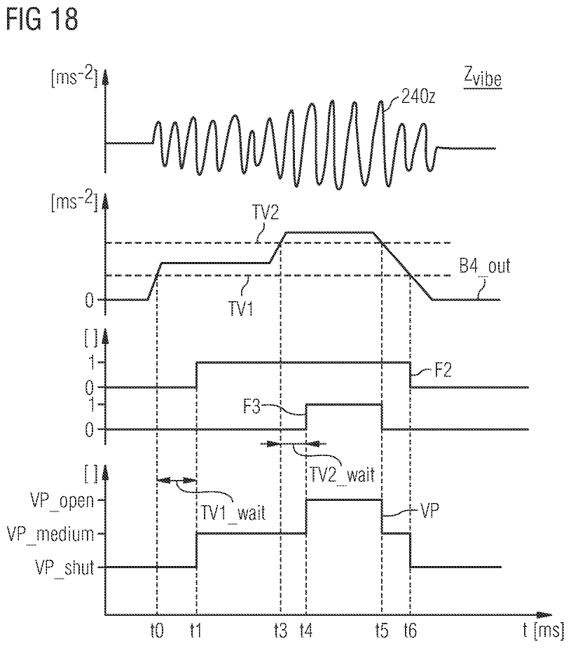

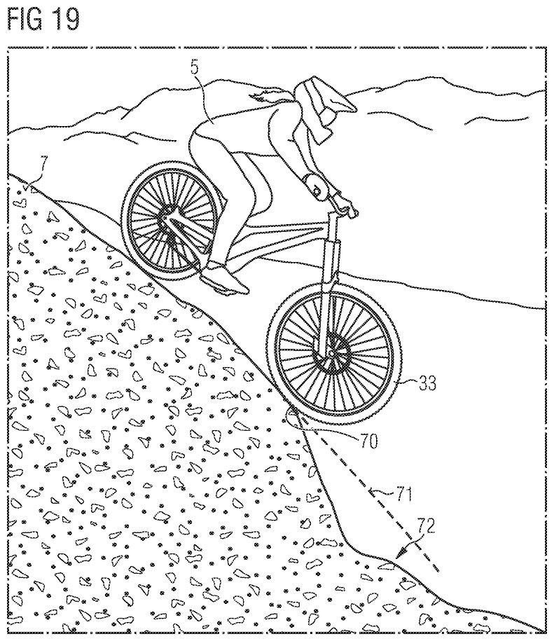

FIG. 18 illustrates the response of the control arrangement to a situation in which the bike is being ridden over ridged terrain (a stony path, a series of firm tyre tracks or other parallel ridges, etc.) and a shock absorber encounters low- to medium-force impacts in quick succession. The uppermost curve is the approximately sinusoidal Z-axis accelerometer signal 240z as the bike is ridden over a series of bumps, perceived as vibration Zvibe by the cyclist. The next curve B4_out is the root-mean-square of the high-pass filtered Z-axis signal. When this variable B4_out exceeds a “low amplitude” vibration threshold TV1 for a predefined minimum duration TV1_wait, for example impacts in the order of 2.4 g are felt by the rider for at least 2 seconds, a flag F2 is set to “high”, and the valve position VP of the front shock absorber changes from “shut” to “medium” as indicated in the lowermost graph. Here, the “low amplitude” vibration threshold TV1 is exceeded at time to and persists for more than the minimum duration TV1_wait, so that flag F2 is set to “high” at time t1, and the front shock absorber changes from “shut” to “medium”. When the variable B4_out exceeds a “high amplitude” vibration threshold TV2 for a predefined minimum duration TV2_wait, for example impacts in the order of 6 g are felt by the rider for at least 2 seconds, a flag F3 is set to “high”, and the valve position VP of the front shock absorber changes to “open”. Here, the “high amplitude” vibration threshold TV2 is exceeded at time t3 and persists for more than the minimum duration TV2_wait, so that flag F3 is set to “high” at time t4, and the front shock absorber changes from “medium” to “open”. When the curve B4_out drops below a threshold TV2, TV1 the corresponding flag F3, F2 is reset (at times t5, t6 respectively as shown here) and the valve position VP of the front shock absorber changes again from “open” to “medium” or from “medium” to “shut” as appropriate.

FIG. 19 illustrates a situation in which the inventive suspension assembly responds to a sudden downward displacement of the front wheel 33. Here, the rider 5 is travelling downhill, seated far back in the downhill position. The terrain 7 becomes abruptly steeper at point 70 and the front wheel 33 will drop suddenly relative to the handlebars. However, the change in downward slope (relative to the projected slope 71) is not so great as to qualify as a “drop” with ensuing free fall of the bike 3. Instead, the change in downward slope is such that the front wheel 33 maintains contact with the ground 7. In this situation, the damper of the inventive suspension assembly reacts by opening fully in anticipation of the subsequent “impact” at point 72 when the unsprung mass (the front wheel 33) would act to push the fork lowers upwards again.

Although the present invention has been disclosed in the form of preferred embodiments and variations thereon, it will be understood that numerous additional modifications and variations could be made thereto without departing from the scope of the invention. For example, in the case of a mountain-bike with full electronic suspension, the rear shock absorber may be equipped with a servomotor and a driver that is also controlled by the control arrangement described above. A wireless interface of the control arrangement can be a Bluetooth module or similar to allow smartphone connection with a dedicated app.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

### LIST OF REFERENCE SIGNS

compression valve 1
long axis 1A
valve main body 10
divider 10D
axial blind hole 100
primary through-hole 101
secondary through-hole 102
barrel 11
aperture 11A
slot 11S
pin 111
pin seat 112
coupling interface 11C
fluid port 12
valve end cap 13
damper 2
cartridge 20C
pressure tube 20P
threaded connector 200
floating piston 201
inner threaded part 202
reservoir 20R
plunger 21
DC motor 22
transmission joint 23
control arrangement 24
valve control signal 24out
accelerometer 240AS
accelerometer output 240x, 240y, 240z
pressure sensor 240PS
pressure sensor output 240p
motion sensor 240MS
motion sensor output 240m
DSP module 241
decision module 242
encoder 243
wireless interface 244
slope computation block 245
recovery time computation block 246
shock threshold computation block 247
comparator module 248
timer reset block 249
computation block B1, . . . , Bn
decision block D1, D2
computation result B1_out, . . . , Bn_out
flag F1, F2, F3
threshold TH1, TV1, TV2
time t0, t1, t2, t3, t4, t5, t6
valve position VP_open
valve position VP_medium
valve position VP_shut
mountain-bike 3
head tube 30
down tube 31
seat tube 32
handlebar 33
suspension assembly 4
telescopic fork 41
stanchion 410
crown 411
fork lower 412
arch 413
damper control unit 414
top cap 415
rear shock absorber 42
battery pack 43
mountain biker 5
uphill obstacle 6
downhill terrain 7, 70, 71, 72
upward pull Zlift
vibration Zvibe
needle valve 9
main body 90
needle 91

1. A compression valve (1) for a damper (2) of a suspension assembly (4) of a two-wheeled vehicle (3), the compression valve (1) comprising
a cylindrical main body (10) adapted to be arranged along a longitudinal axis (2A) of the damper (2), the main body (10) comprising an interior cavity (100) in the form of an axial blind hole (100);
a through-passage (101, 102) arranged to provide a fluid path (P₁₀₁, P₁₀₂) between a pressure tube (20P) and a reserve tube (20R) of the damper (2);
a rotatable body (11) shaped to engage with the main body (10), which rotatable body (11) is rotatable between a first position (VP_open, VP_medium) in which the rotatable body (11) opens a fluid path (P₁₀₁, P₁₀₂), and a second position (VP_shut) in which the rotatable body (11) closes all fluid paths (P₁₀₁, P₁₀₂).

2. A compression valve according to claim 1, wherein the rotatable body (11) is shaped to fit about the upper end of the main body (10).

3. A compression valve according to claim 1, comprising a primary lateral passage (101) and a secondary lateral passage (102), wherein the cross-sectional area of the secondary lateral passage (102) is in the order of 10-30 times smaller than the cross-sectional area of the primary lateral passage (101).

4. A compression valve according to claim 1, wherein a primary lateral passage (101) has a cross-sectional area in the order of 5 mm²-15 mm².

5. A compression valve according to claim 1, wherein a secondary lateral passage (102) has a cross-sectional area in the order of 0.2 mm²-5 mm².

6. A compression valve according to claim 1, wherein the rotatable body (11) comprises a coupling interface (11C) to facilitate coupling to a transmission link (23) between the compression valve (1) and a valve actuator (22).

7. A damper (2) comprising a compression valve (1) according to claim 1 to regulate fluid flow between the reserve tube (20R) and the pressure tube (20P) of the damper (2).

8. A damper according to claim 7, comprising a valve actuator (22) coupled to the rotatable body (11) of the compression valve (1).

9. A suspension assembly (4) of a bicycle (3), which suspension assembly (4) comprises a telescopic tube fork (41) arranged between the bicycle header tube (30) and the front wheel axle, which telescopic tube fork (41) comprises a pair of stanchions (410) and a damper (2) according to claim 7 arranged in the interior of one stanchion (410).

10. A suspension assembly according to claim 9, comprising
a sensor arrangement (240AS, 240P, 240M) configured to generate an output signal (240x, 240y, 240z, 240p, 240m) in response to a displacement of the sprung mass;
an electronically controlled valve actuator (22) coupled to the rotatable body (11) of the compression valve (1); and
a control arrangement (24) configured to operate the electronically controlled valve actuator (22) on the basis of a sensor arrangement output signal (240x, 240y, 240z, 240p, 240m).

11. A suspension assembly according to claim 9, wherein the sensor arrangement comprises a 3-axis accelerometer (240AS) that can detect motion along three orthogonal axes.

12. A method of controlling a suspension assembly (4) according to claim 10, comprising the steps of
analysing the output signals (240x, 240y, 240z, 240p, 240m) of the sensor arrangement (240AS, 240P, 240M) to detect an upward displacement (Z_{lift}) of the sprung mass;
operating the electronically controlled valve actuator (22) on the basis of the detected upward displacement (Z_{lift}).

13. A method according to claim 12, comprising a step of operating the electronically controlled valve actuator (22) to open the compression valve (1) in response to the detected upward displacement (Z_{lift}) of the sprung mass.

14. A method according to claim 12, wherein the rotatable body (11) of the compression valve (1) is turned to open a fluid path (P₁₀₁, P₁₀₂) in response to the detected upward displacement of the sprung mass.

15. A computer program product comprising a computer program that is directly loadable into a memory of the control arrangement (24) of an electronic suspension (4) according to claim 10, and which comprises program elements for performing steps of the method of analysing the output signals (240x, 240y, 240z, 240p, 240m) of the sensor arrangement (240AS, 240P, 240M) to detect an upward displacement (Z_{lift}) of the sprung mass; and
operating the electronically controlled valve actuator (22) on the basis of the detected upward displacement (Z_{lift});
when the computer program is executed by a processor of the control arrangement (24).
